(19) United States
(12) Patent Application Publication
(10) Pub. No.: US 2012/0094016 A1
(43) Pub. Date: Apr. 19, 2012

(54) ELECTRODE MATERIAL FOR ALUMINUM ELECTROLYTIC CAPACITOR AND METHOD FOR MANUFACTURING THE MATERIAL

(75) Inventors: Toshifumi Taira, Osaka-shi (JP); Masashi Mehata, Osaka-shi (JP)

(73) Assignee: TOYO ALUMINIUM KABUSHIKI KAISHA, Osaka-shi, Osaka (JP)

(21) Appl. No.: 13/378,443

(22) PCT Filed: May 25, 2010
(86) PCT No.: PCT/JP2010/058805

§ 371 Date: Dec. 15, 2011

(30) Foreign Application Priority Data
Jun. 15, 2009 (JP) 2009-142074

(51) Int. Cl. B05D 5/12; B32B 15/02; B22F 1/00; C25D 11/16; C25D 7/00

(52) U.S. Cl. 427/80; 205/190; 75/249

(57) ABSTRACT

The present invention provides an electrode material for aluminum electrolytic capacitors that has a high porosity and a high capacitance, and that does not require etching.

Specifically, the invention provides an electrode material for aluminum electrolytic capacitors that contains a sintered body of at least one of aluminum and aluminum alloys, the sintered body having a porosity of 35 to 55%.

### TECHNICAL FIELD

The present invention relates to an electrode material used for an aluminum electrolytic capacitor, particularly a positive electrode material used for a medium- to high-voltage aluminum electrolytic capacitor, and a method for producing the electrode material.

### BACKGROUND ART

The main capacitors currently in use include aluminum electrolytic capacitors, tantalum electrolytic capacitors, and ceramic capacitors.

Ceramic capacitors are produced by sandwiching a barium titanate dielectric between precious metal plates, and then sintering. Ceramic capacitors, which have a thick dielectric, have a lower capacitance than aluminum electrolytic capacitors and tantalum electrolytic capacitors. However, ceramic capacitors are characteristically small in size, and have difficulty generating heat.

Tantalum electrolytic capacitors comprise a tantalum powder and an oxide film formed thereon. Tantalum electrolytic capacitors characteristically have a capacitance lower than that of aluminum electrolytic capacitors and higher than that of ceramic capacitors; and are less reliable than ceramic capacitors, but more reliable than aluminum electrolytic capacitors.

Based on such characteristic differences, ceramic capacitors are, for example, used for compact electronics such as cellular phones; tantalum electrolytic capacitors are used for household electric appliances such as televisions; and aluminum electrolytic capacitors are used for inverter power supplies for hybrid vehicles, and for storage of wind-generated electricity.

As described above, aluminum electrolytic capacitors have been widely used in the field of energy due to their characteristic properties. Aluminum foil is generally used as an electrode material for aluminum electrolytic capacitors.

The surface area of an electrode material for an aluminum electrolytic capacitor can usually be increased by performing an etching treatment to form etching pits. The etched surface of the electrode material is then anodized to form thereon an oxide film, which functions as a dielectric. Accordingly, by etching the aluminum foil and applying to the surface thereof one of various voltages selected to match the voltage to be used so as to form an aluminum anodic oxide film, various aluminum anodes (foils) for electrolytic capacitors that are suited to specific applications can be produced.

In the etching process, pores called etching pits are formed in an aluminum foil. The etching pits are formed into various shapes according to the anodizing voltage applied.

More specifically, a thick oxide film must be formed for use in medium- to high-voltage capacitors. Therefore, in order to prevent etching pits from being buried by such a thick oxide film, etching pits of an aluminum foil for medium- to high-voltage anodes are shaped into a tunnel mainly by conducting direct-current etching, and then formed to an appropriate thickness according to the voltage applied. In contrast, small etching pits are necessary for use in low-voltage capacitors. Therefore, sponge-like etching pits are formed mainly by alternating-current etching. The surface area of a cathode foil is similarly increased by etching.

However, these etching treatments require the use of an aqueous hydrochloric acid solution that contains sulfuric acid, phosphoric acid, nitric acid, etc., in hydrochloric acid. More specifically, hydrochloric acid leads to increased environmental burden, and its disposal is also a burden on the production process and on the economy. Therefore, the development of a novel method for increasing the surface area of an aluminum foil, which does not require etching, has been in demand.

In order to meet this demand, an aluminum electrolytic capacitor characterized by using an aluminum foil having a fine aluminum powder adhering to the surface thereof has been proposed (see, for example, Patent Literature (PTL) 1). Another example of a known electrolytic capacitor is one that uses an electrode foil that comprises a flat aluminum foil having a thickness of not less than 15 μm but less than 35 μm, wherein an aggregate of self-similar aluminum fine particles having a length of 2 to 0.01 μm and/or aluminum fine particles having an aluminum oxide layer formed on the surface thereof is adhered to one or both surfaces of the flat aluminum foil (Patent Literature (PTL) 2).

However, the methods disclosed in the aforementioned documents, wherein aluminum powder is adhered to the aluminum foil by plating and/or vacuum evaporation, are insufficient, at least for obtaining a substitute for thick etching pits for medium- to high-voltage capacitors.

Further, as an electrode material for aluminum electrolytic capacitors that does not require etching, an electrode material for aluminum electrolytic capacitors comprising a sintered body of at least one of aluminum and aluminum alloys is disclosed (see, for example, Patent Literature (PTL) 3). This sintered body has a unique structure formed by sintering aluminum or aluminum alloy powder particles while maintaining a space between each particle; therefore, the sintered body is considered to have a capacitance that is equivalent to or higher than that of a conventional etched foil (paragraph [0012] of Patent Literature (PTL) 3).

However, the technique disclosed in Patent Literature (PTL) 3 is insufficient in controlling the space formed between each particle, and porosity. Accordingly, there arise problems such that the space may be buried upon formation of an anodic oxide film by application of one of various voltages to match the voltage to be used, or such that it is difficult to obtain a desired electric capacity due to an excessively wide distance between each space.

### Citation List

Patent Literature

PTL 1: Japanese Unexamined Patent Publication No. H2-267916

PTL 2: Japanese Unexamined Patent Publication No. 2006-108159

PTL 3: Japanese Unexamined Patent Publication No. 2008-98279

### SUMMARY OF INVENTION

### Technical Problem

An object of the present invention is to provide an electrode material for aluminum electrolytic capacitors, for which etching is not necessary, and a method for producing the electrode material for aluminum electrolytic capacitors.

### Solution to Problem

The present inventors conducted extensive research to achieve the above object, and found that a method for producing a specific paste composition, and an electrode material produced by the method can achieve the above object. The present invention has been accomplished based on this finding.

More specifically, the present invention provides the following electrode material for aluminum electrolytic capacitors, and method for producing the electrode material.

1. An electrode material for aluminum electrolytic capacitors, comprising a sintered body of at least one of aluminum and aluminum alloys, the sintered body having a porosity of 35 to 55%.

2. A method for producing an electrode material for aluminum electrolytic capacitors, the method comprising the steps of:
Step (1): forming on a substrate a film of a paste composition comprising a powder of at least one of aluminum and aluminum alloys, and a cellulose resin other than nitrocellulose resin; and
Step (2): sintering the film at a temperature not lower than 560° C. and not higher than 660° C.; the method not comprising an etching step.

3. The method according to Item 2, wherein the cellulose resin other than nitrocellulose resin is at least one member selected from the group consisting of methyl cellulose, ethyl cellulose, benzyl cellulose, trityl cellulose, cyanoethyl cellulose, carboxymethyl cellulose, carboxyethyl cellulose, aminoethyl cellulose, and oxyethyl cellulose.

4. The method according to Item 2, wherein the powder has an average particle diameter of not less than 1 μm and not more than 80 μm.

5. The method according to Item 2, which further comprises Step (3): anodizing the sintered film.

### Advantageous Effects of Invention

The present invention can provide an electrode material comprising a sintered body, which is different from conventional electrode materials (rolled foils) having etching pits. Such a sintered body has a particularly unique structure obtained by sintering particles (particularly, aluminum or aluminum alloy powder particles) while an appropriate space is maintained between each particle. Because of this structure, a capacitance equivalent to or greater than that of conventional etched foils and electrode materials can be obtained. In particular, the space between the particles corresponds to a high porosity of 35 to 55% in the sintered body. Thus, a large capacitance corresponding to the high porosity can be obtained.

According to the production method of the present invention, a specific paste composition (particularly a resin binder) is used, whereby the porosity can be easily controlled, and thus the capacitance can be easily controlled. Therefore, the present invention can be particularly suitable as a substitute for an etched foil having thick etching pits for use in medium-to high-voltage capacitors.

Thus, the electrode material of the present invention, which can be used without etching, can solve all of the problems caused by hydrochloric acid used for etching (e.g., environmental problems and waste water pollution problems).

Furthermore, conventional etched foils have a problem in which foil strength deteriorates due to etching pits. In contrast, the electrode material of the present invention, which comprises a porous sintered body, is advantageous in terms of strength. Accordingly, the electrode foil of the present invention can be satisfactorily wound.

### DESCRIPTION OF EMBODIMENTS

1. Electrode Material for Aluminum Electrolytic Capacitors

The electrode material of the present invention is used for an aluminum electrolytic capacitor. Features of this electrode material are that the electrode material comprises a sintered body of at least one of aluminum and aluminum alloys, and that the sintered body has a porosity of 35 to 55%.

The sintered body is substantially composed of at least one member selected from the group consisting of aluminum and aluminum alloys. The material composition of such a sintered body may be the same as that of a known rolled aluminum foil. For example, a sintered body of aluminum or a sintered body of an aluminum alloy can be used. The aluminum sintered body preferably comprises aluminum having a purity of 99.8 wt % or more. Examples of components of aluminum alloys include one or more elements selected from silicon (Si), iron (Fe), copper (Cu), manganese (Mn), magnesium (Mg), chromium (Cr), zinc (Zn), titanium (Ti), vanadium (V), gallium (Ga), nickel (Ni), boron (B), zirconium (Zr), and the like. The content of each of these elements is preferably not more than 100 ppm by weight, and more preferably not more than 50 ppm by weight.

The sintered body is produced by sintering particles of at least one of aluminum and aluminum alloys while maintaining a space between each particle. The particles connect to each other while maintaining an appropriate space therebetween to form a three-dimensional network. By using such a porous sintered body, sufficient capacitance can be obtained without the need for etching.

In the present invention, the space between each particle corresponds to a high porosity, i.e., 35 to 55%, and is preferably 40 to 50%. When the porosity is less than 35% or more than 55%, it is difficult to obtain a capacitance equivalent to or more than a conventional electrode material having etching pits. The porosity can be controlled, for example, by adjusting the shape and particle diameter of the aluminum or aluminum alloy powder used as a starting material, and the formulation of the paste composition containing the powder (particularly the resin binder used).

Although there is no particular limitation on the shape of the sintered body, a foil-like shape having an average thickness of not less than 5 μm and not more than 1,000 μm is generally preferable. A foil-like shape having an average thickness of not less than 5 μm and not more than 50 μm is particularly preferable. The average thickness is an average of thickness values measured at ten points by a micrometer.

The electrode material of the present invention may further contain a substrate that supports the electrode material. Although there is no particular limitation on the substrate, an aluminum foil can be suitably used.

There is no particular limitation on the aluminum foil used as a substrate. Pure aluminum or an aluminum alloy can be used. The composition of the aluminum foil used in the present invention may contain an aluminum alloy that contains a necessary amount of at least one alloy element selected from silicon (Si), iron (Fe), copper (Cu), manganese (Mn), magnesium (Mg), chromium (Cr), zinc (Zn), titanium (Ti), vanadium (V), gallium (Ga), nickel (Ni), and boron (B), or aluminum that contains a limited amount of the aforementioned elements as unavoidable impurities.

Although there is no particular limitation on the thickness of the aluminum foil, the thickness is preferably not less than 5 μm and not more than 100 μm, and particularly preferably not less than 10 μm and not more than 50 μm.

An aluminum foil produced by a known method can be used as the aluminum foil of the present invention. Such an aluminum foil can be obtained, for example, by preparing a molten metal of aluminum or an aluminum alloy of the above-mentioned composition, casting the molten metal to obtain an ingot, and subjecting the ingot to appropriate homogenization. The resulting ingot is then subjected to hot rolling and cold rolling to obtain an aluminum foil.

During the aforementioned cold rolling process, intermediate annealing may be conducted at a temperature within a range of not lower than 50° C. to not higher than 500° C., and particularly not lower than 150° C. to not higher than 400° C. After the cold rolling process, annealing may be conducted at a temperature range of not lower than 150° C. to not higher than 650° C., and particularly not lower than 350° C. to not higher than 550° C. to obtain a soft foil.

The electrode material of the present invention may be used as a low-voltage, medium-voltage or high-voltage aluminum electrolytic capacitor. In particular, the electrode material is suitable for use as a medium-voltage or high-voltage (medium- to high-voltage) aluminum electrolytic capacitor.

When used as an electrode for aluminum electrolytic capacitors, the electrode material of the present invention can be used without being subjected to etching. More specifically, the electrode material of the present invention may be used as an electrode (electrode foil) as is or by only being subjected to anodization, without the need for etching.

An electrolytic capacitor can be obtained by a process comprising: laminating an anode foil prepared by using the electrode material of the present invention, and a cathode foil with a separator therebetween; winding the laminate to form a capacitor element; impregnating the electrode with an electrolyte; and housing the capacitor element containing the electrode in a case; and sealing the case with a sealing material.

2. Method for Producing Electrode Material for Aluminum Electrolytic Capacitors

The method for producing the electrode material for aluminum electrolytic capacitors of the present invention has the following features. The method comprises the steps of:

Step (1): forming a film of a paste composition comprising at least one of an aluminum powder and aluminum alloy powders, and a cellulose resin other than nitrocellulose resin on a substrate; and

Step (2): sintering the film at a temperature not lower than 560° C. and not higher than 660° C. The method does not comprise an etching step.

In particular, the use of a specific paste composition in Step 1 is a feature of the production method of the present invention that has the above features. By using a cellulose resin other than nitrocellulose as an essential component of the paste composition, aluminum or aluminum alloy powder particles can be sintered while an appropriate space (porosity: 35 to 55%) is maintained between each particle, which results in an advantage in that capacitance of the electrode material can be easily controlled and enhanced.

Each of the steps is explained below in detail.

(First Step)

In Step 1, a film of a composition comprising at least one of an aluminum powder and aluminum alloy powders, and a cellulose resin other than nitrocellulose resin is formed on a substrate.

The composition (components) of aluminum or aluminum alloys may be one as mentioned above. For example, a pure aluminum powder having a purity of 99.8 wt % or more is preferably used as the powder.

There is no particular limitation on the shape of the powder, and a spherical, amorphous, scaly, fibrous, or other shape may be suitably used. A powder of spherical particles is particularly preferable. The average particle diameter of the spherical particle powder is preferably not less than 0.1 μm and not more than 80 μm, and more preferably not less than 0.1 μm and not more than 30 μm. When the average particle diameter is less than 0.1 μm, a desired withstand voltage may not be obtained. Conversely, when the average particle diameter is more than 80 μm, a satisfactory electrostatic capacity may not be obtained.

A powder produced by a known method may be used as the powder described above. Examples of usable methods include an atomizing method, a melt spinning process, a rotating disk method, a rotating electrode process, and other rapid solidification processes. In terms of industrial production, an atomizing method, in particular, a gas atomizing method, is preferable. More specifically, a powder obtained by atomizing molten metal is preferably used.

As the resin binder contained in the paste composition, a cellulose resin other than nitrocellulose resin is contained as an essential component in the present invention. When the composition contains such a specific cellulose resin, aluminum or aluminum alloy powder particles can be sintered while a suitable space (porosity: 35 to 55%) is maintained between each particle, thereby controlling and enhancing the capacitance of the electrode material. As such a specific cellulose resin, at least one member selected from the group consisting of methyl cellulose, ethyl cellulose, benzyl cellulose, trityl cellulose, cyanoethyl cellulose, carboxymethyl cellulose, carboxyethyl cellulose, aminoethyl cellulose, and oxyethyl cellulose is preferably used.

The content of the cellulose resin other than nitrocellulose resin is preferably 30 wt % or more, and more preferably 50 wt % or more.

Insofar as the paste composition contains such a specific cellulose resin as an essential component, other resin binders may also be contained therein. Examples of other resin binders include carboxy-modified polyolefin resins, vinyl acetate resins, vinyl chloride resins, vinyl chloride-vinyl acetate copolymer resins, vinyl alcohol resins, butyral resins, vinyl fluoride resins, acrylic resins, polyester resins, urethane resins, epoxy resins, urea resins, phenol resins, acrylonitrile resins, nitrocellulose resins, paraffin wax, polyethylene wax, and other synthetic resins and waxes; and tar, glue, sumac, pine resin, beeswax, and other natural resins and waxes.

The amount of resin binder is 1 to 50 mass %, and preferably 2 to 10 mass %, based on the above powder. When the amount of resin binder is less than 1 mass %, application to a substrate becomes difficult, and the sintered body may be peeled from the substrate after sintering. When the amount of resin binder exceeds 50 mass %, a desired porosity is difficult to obtain, and it is also difficult to form a porous sintered body wherein particles are three-dimensionally sintered to each other.

The paste composition may contain, if necessary, known or commercially available solvents, sintering aids, surfactants, etc. Examples of usable solvents include water and organic solvents, such as ethanol, toluene, ketones, and esters.

The film can be formed, for example, by a coating method, such as rolling, brushing, spraying, or dipping, or by a known printing method.

The film may be dried at a temperature within a range of not lower than 20° C. to not higher than 300° C., if necessary.

Although there is no particular limitation on the thickness of the film, the thickness is generally not less than 20 μm and not more than 1,000 μm, and particularly preferably not less than 20 μm and not more than 200 μm. When the thickness is less than 20 μm, a desired capacitance may not be obtained. Conversely, when the thickness is greater than 1,000 μm, insufficient adhesion of the film to the foil and formation of cracks in a subsequent step may occur.

The material of the substrate is not particularly limited. For example, any of metal, resin, and the like may be used. In particular, when only the film is to be left by volatilizing the substrate during sintering, a resin (resin film) can be used. When the substrate is to be left, a metal foil can suitably be used. An aluminum foil is particularly suitable for use as a metal foil. When an aluminum foil is used, the composition of the aluminum foil may be different from or substantially the same as that of the film. Prior to the formation of the film, the surface of the aluminum foil may be roughened. The surface roughening method is not particularly limited, and any known technique, such as washing, etching, or blasting, may be employed.

(Second Step)

In Step 2, the film is sintered at a temperature not lower than 560° C. and not higher than 660° C.

The sintering temperature is not lower than 560° C. and not higher than 660° C., preferably not lower than 560° C. but lower than 660° C., and more preferably not lower than 570° C. and not higher than 659° C. The sintering time, which varies depending on the sintering temperature, etc., can be suitably determined generally within the range of about 5 to 24 hours.

The sintering atmosphere is not particularly limited, and may be any of a vacuum atmosphere, an inert gas atmosphere, an oxidizing gas atmosphere (air), a reducing atmosphere, and the like. In particular, a vacuum atmosphere or a reducing atmosphere is preferable. The pressure conditions may also be any of a normal pressure, a reduced pressure, and an increased pressure.

After Step 1 but prior to Step 2, a heat treatment (degreasing treatment) is preferably conducted in such a manner that the temperature is maintained within the range of not lower than 100° C. to not higher than 600° C. for 5 hours or more. The heating atmosphere is not particularly limited, and may be, for example, any of a vacuum atmosphere, an inert gas atmosphere, and an oxidizing gas atmosphere. The pressure conditions may also be any of a normal pressure, a reduced pressure, and an increased pressure.

(Third Step)

The electrode material of the present invention can be obtained in Step 2 described above. The electrode material can be directly used as an electrode (electrode foil) for an aluminum electrolytic capacitor without etching. Alternatively, the electrode material of the present invention may be anodized in Step 3, if necessary, to form a dielectric, which is used as an electrode.

Although there is no particular limitation on the anodization conditions, the anodization may typically be conducted by applying a current of about not less than 10 mA/cm² and not more than 400 mA/cm² to the electrode material for not less than 5 minutes in a boric acid solution with a concentration of not less than 0.01 mol and not more than 5 mol at a temperature of not lower than 30° C. and not higher than 100° C.

### EXAMPLES

The present invention is described in more detail below with reference to Conventional Examples and Examples. However, the scope of the present invention is not limited to the Examples.

The electrode materials of the Conventional Examples and the Examples were prepared by the following procedure. The capacitance of the obtained electrode materials and the porosity of the sintered bodies excluding the substrates of the electrode materials were measured.

(Capacitance)

After each electrode material was subjected to a chemical conversion treatment at 450 V and 550 V in an aqueous boric acid solution (50 g/L), the capacitance was measured in an aqueous ammonium borate solution (3 g/L). The measured projected area was 10 cm².

(Porosity)

Samples (15 cm×5.5 cm) were cut out from the electrode material and the substrate used. The porosity was calculated according to the following formula:

Porosity (%)=[1-{Mass (g) of the electrode material−Mass (g) of the substrate}]/[Thickness of the electrode material*¹(cm)×Area of the sample (cm²)×Specific gravity of aluminum (2.70 g/cm³)−Mass (g) of the substrate]

*¹) The average of thickness values measured at a total of 5 points, i.e., four corners and the center, of the sample, by a micrometer.

### Conventional Example 1

An aluminum powder with an average particle diameter of 5.0 μm (JIS A1080-H18, a product of Toyo Aluminium K.K.) was mixed with a coating binder acrylic resin (Toyo Ink Co., Ltd.), and the mixture was dispersed in a solvent (toluene-IPA) to obtain a coating composition with a solids content shown in Table 1. The coating composition was applied to both sides of a 30 μm-thick aluminum foil (JIS 1N30-H18) to substantially the same thickness using a comma coater, and the resulting film was dried. The aluminum foil was sintered in an argon gas atmosphere at a temperature of 615° C. for 7 hours to produce an electrode material. The thickness of the electrode material after sintering was about 130 μm.

Table 1 below shows the capacitance and porosity of the obtained electrode material.

### Conventional Example 2

A 130-μm-thick aluminum foil (JIS A1080-H18) (Fe: 25 mass ppm, Si: 40 mass ppm, Cu: 40 mass ppm, the remainder: Fe and unavoidable impurities; a product of Toyo Aluminium K.K.) was subjected to an etching treatment under the conditions shown below, and the etched aluminum foil was washed and dried to produce an electrode material.

(Primary Etching)

Etchant: a mixture of hydrochloric acid and sulfuric acid (hydrochloric acid concentration: 1 mol/L, sulfuric acid concentration: 3 mol/L, 80° C.)

Electrolysis: DC 500 mA/cm²×1 min

(Secondary Etching)

Etchant: a nitric acid solution (nitric acid concentration: mol/L, 75° C.)

Electrolysis: DC 100 mA/cm²×5 min

### Examples 1 to 9

A cellulose resin other than nitrocellulose was dissolved in a solvent (toluene-IPA), and an aluminum powder having an average particle diameter of 5.0 μm (JIS A1080, a product of Toyo Aluminium K.K.) was mixed therewith and dispersed therein to produce a coating composition having a solids content shown in Table 1. The coating composition was applied to both sides of a 30-μm-thick aluminum foil (JIS 1N30-H18) to substantially the same thickness using a comma coater, and the resulting film was dried. This aluminum foil was sintered in an argon gas atmosphere at a temperature of 615° C. for 7 hours, thereby producing an electrode material. The thickness of the electrode material after sintering was about 130 μm.

Table 1 shows the capacitance and porosity of the obtained electrode material.

TABLE 1

| | Weight of | Resin | | Solids | | | |
|---|---|---|---|---|---|---|---|
| | aluminum | | Weight | content | Capacitance (μF/10 cm²) | | Porosity |
| | powder (g) | Kind | (g) | (%) | 400 V | 550 V | (%) |
| Conventional | 200 | Acrylic resin | 10.2 | 56.8 | 11.3 | 6.3 | 32.5 |
| Example 1 | | | | | | | |
| Conventional | 200 | Acrylic resin | 20.0 | 55.0 | 11.9 | 6.9 | 33.0 |
| Example 2 | | | | | | | |
| Example 1 | 200 | Ethyl cellulose | 4.0 | 68.0 | 12.6 | 7.3 | 35.1 |
| Example 2 | 200 | Ethyl cellulose | 5.2 | 62.2 | 15.2 | 8.5 | 38.9 |
| Example 3 | 200 | Ethyl cellulose | 6.0 | 58.9 | 15.7 | 8.9 | 40.6 |
| Example 4 | 200 | Ethyl cellulose | 10.2 | 56.8 | 15.6 | 9.2 | 42.7 |
| Example 5 | 200 | Ethyl cellulose | 14.4 | 59.6 | 16.8 | 9.3 | 43.9 |
| Example 6 | 200 | Ethyl cellulose | 17.0 | 58.6 | 16.5 | 9.8 | 45.4 |
| Example 7 | 200 | Ethyl cellulose | 20.0 | 55.0 | 16.4 | 9.6 | 48.1 |
| Example 8 | 200 | Ethyl cellulose | 26.0 | 68.5 | 16.2 | 9.3 | 51.8 |
| Example 9 | 200 | Ethyl cellulose | 34.0 | 63.2 | 15.7 | 9.0 | 54.7 |

In Conventional Examples 1 and 2 and Examples 1 to 9, electrode materials were produced by production methods not comprising etching. The electrode materials obtained in Conventional Examples 1 and 2 have a porosity of less than 35%, and are also insufficient in terms of capacitance. In contrast, the electrode materials obtained in Examples 1 to 9 have a high porosity, i.e., not less than 35%, and have sufficient capacitance corresponding to the high porosity. The electrode foil for aluminum electrolytic capacitors of the present invention is advantageous in that sufficient capacitance can be ensured without the need for etching treatment that is extremely burdensome from an environmental standpoint, and that also leads to a reduction in the foil strength.

1. An electrode material for aluminum electrolytic capacitors, comprising a sintered body of at least one of aluminum and aluminum alloys, the sintered body having a porosity of 35 to 55%.

2. A method for producing an electrode material for aluminum electrolytic capacitors, the method comprising the steps of:
Step (1): forming on a substrate a film of a paste composition comprising a powder of at least one of aluminum and aluminum alloys, and ethyl cellulose resin; and
Step (2): sintering the film at a temperature not lower than 560° C. and not higher than 660° C.; the method not comprising an etching step.

3. (canceled)

4. The method according to claim 2, wherein the powder has an average particle diameter of not less than 1 μm and not more than 80 μm.

5. The method according to claim 2, which further comprises Step (3): anodizing the sintered film.
